(19) United States
(12) Patent Application Publication
(10) Pub. No.: US 2011/0055713 A1
(43) Pub. Date: Mar. 3, 2011

(54) INTERACTIVE DELIVERY OF EDITORAL CONTENT

(76) Inventors: Robert Lee Gruenewald, Edmond, OK (US); Terry Dan Storch, Edmond, OK (US)

(21) Appl. No.: 12/665,606

(22) PCT Filed: Jun. 25, 2008
(86) PCT No.: PCT/US08/07888

§ 371 Date: Jun. 21, 2010

Related U.S. Application Data
(60) Provisional application No. 60/937,241, filed on Jun. 25, 2007.
(60) Provisional application No. 60/962,850, filed on Jul. 31, 2007.

(51) Int. Cl. G06F 15/16; G06F 3/01

(52) U.S. Cl. 715/738; 709/217

(57) ABSTRACT

A method for electronically providing material to a user such that the user can receive, and preferably transmit, editorial content linked to a selectable portion of the material enables a user to have access to material electronically distributed over a communication network, such as the Internet. In one implementation a Web application displays the contents of a book in a browser-based reader and an indication of the amount of commentary associated with selectable portions of the book. A user can select portions of the book and associate media of different formats such as audio, video, image, URLs, in addition to text, with the selected portion(s) of the book. A user can also see a list of associated content contributed by herself/himself or by other users (unless optionally designated private). By choosing any item in the list of associated content, the content is dynamically displayed within the user's reader.

### CROSS-REFERENCE TO RELATED APPLICATIONS

Priority is claimed from U.S. Provisional Application Ser. No. 60/937,241, entitled “Interactive Delivery of Editorial Content” and filed Jun. 25, 2007, and U.S. Provisional Application Ser. No. 60/962,850, entitled “Interactive Delivery of Editorial Content” and filed Jul. 31, 2007, contents of which are incorporated herein by reference.

### FIELD OF THE INVENTION

The present invention relates to methods of interactively electronically communicating material for widespread access and comment, which comment can take a variety of forms. One particular field of application is interactive Internet Web 2.0 access to electronic literary works about which users can transmit onto and receive from the Internet video, image, audio, in addition to text, commentary about a selected literary work or part thereof.

### BACKGROUND OF THE INVENTION

Local and wide area communication networks are known. A specific example is the Internet, whose structures, functions and protocols are known. Also well known are the variety of Web browsers that can be used to access the Internet and specifically its World Wide Web (the Web). Web 2.0 concepts, such as the Internet as a platform for interactive community building and information sharing, are also known. These provide the environment within which preferred embodiments of the present invention are used.

Electronic literary works (i.e., literary works whose content is in digital form and accessible electronically) in general and over the Internet, whether such works are electronically originated or converted, are known. The ability to textually comment over the Internet about such works is also known.

### SUMMARY OF THE INVENTION

With the present invention a user has access to material electronically distributed over a communication network, such as the Internet and its World Wide Web (the Web). For example, a Web application displays the contents of a book in a browser-based reader. As users read the book, they have the ability to select portions of the book and then perform one or more novel tasks. One task that a user, can perform is to associate Web media of different formats such as audio, video, image (photos, graphics), URLs, in addition to text, with the portion(s) of the book that the user has selected. In a particular implementation the user can define one or more of these associations as public (visible to other users) or private (only available for viewing by the user who associated it, or by a group of users specified by the user). A user can also see a list of associated content contributed by herself/himself or by other users (if not restricted), which list dynamically changes as users add to, modify or deselect the selected portion(s) of the book. By choosing any item in the list of associated content, the content is dynamically displayed within the user's reader.

In addition to the foregoing advantages of interactivity, versatile commentary format, individual access and control, and dynamic operation, the present invention also enables a community of literary discourse to occur even though the participants are geographically separated and communicating at different times. To assist a particular user to know the activity of discourse or commentary about portions of a work, the present invention also provides a screen display of indicia representing at least the relative activity that has occurred for the various portions.

Therefore from the foregoing, it is a general object of the present invention to provide novel and improved interactive electronically implemented communication methods in which users can at least receive, and preferably also submit, commentary on subjects of interest to the community of users. The commentary can be in a variety of formats, including audio, video, and image in addition to text, and an indication about the amount of editorial content that has been submitted for various portions can be communicated to the users. Other and further objects, features, definitions, and advantages of the present invention will be readily apparent to those skilled in the art when the following description of the preferred embodiments is read in conjunction with the accompanying drawings.

### BRIEF DESCRIPTION OF THE DRAWINGS

FIG. 1 represents a screen capture of a personal webpage showing subject matter for comment and a list of tags for the personal version, “My Version,” selected to display only the tags for the particular user.

FIG. 2 represents a screen capture of a personal webpage showing the subject matter and list with a particular tag selected to display.

FIG. 3 represents a screen capture of a personal webpage of tags for the personal version, “Community,” where a video interactive editorial content link has been selected.

FIG. 4 represents a screen capture of a personal webpage of tags for the personal version, “Community,” where an image interactive editorial content link has been selected.

FIG. 5 represents a screen capture of a personal webpage of tags for the personal version, “Community,” where a URL interactive editorial content link has been selected.

FIG. 6 represents a screen capture of a personal webpage of tags for the personal version, “Community,” where an audio interactive editorial content link has been selected.

FIG. 7 represents a screen capture of a contributing video input screen with which a user can add video editorial content.

FIG. 8 represents a screen capture of a contributing webcam input screen for displaying the webcam video feed being entered.

FIGS. 9-12 represent screen captures from a specific website implementing the present invention.

FIG. 13 represents a screen capture in which portions of displayed material have associated indicia that communicate to a user the relative editorial content activity about the various portions.

### DETAILED DESCRIPTION OF THE INVENTION

The present invention provides a method by which people can electronically communicate to learn about other's, and to share one's own, thoughts about material, wherein such thoughts are expressed in any form including text, audio, video, and image (e.g., graphic and photographic). “Material” here refers to subject matter that people might find worthy of commentary; literary works, such as poems, essays, articles, journals, magazines, and books, for example, are encompassed by the term “material.” A specific example of material provided in a particular implementation of the present invention is the Bible (in various ones of its many versions). One preferable feature of such material for the present invention is that it can be referred to or subdivided into smaller portions than the whole—for example, into chapters, paragraphs, sentences, phrases, and words for a book (or for the Bible, into book, chapter and verse, for example). Preferably these can be grouped, such as groups of words less or more than a sentence, groups of sentences less or more than a paragraph, groups of verses, for example.

To distinguish from the “material” which is the underlying focus of the users of the present invention, such user's contributions to the community of thought about the material are encompassed by the term “editorial content.” Such term includes whatever the user submits as the user's opinion, attitude, reflection, declaration and other commentary, including factual information, about the “material” or another user's “editorial content.” A key feature of such editorial content for the present invention is that it can be of any form that can be digitized and communicated over a communication network, including audio, video, and image (graphic and photographic, for example), in addition to text.

So, the present invention provides a method for electronically providing material to a user such that the user can at least receive editorial content linked to a selectable portion of the material. The “at least receive” language expresses that other capabilities can exist, such as enabling the user to submit his/her own editorial content. Accordingly, the present invention also provides a method for electronically providing material to a user such that the user can transmit and receive editorial content linked to a selectable portion of the material. In a particular implementation this provides a method for enabling interactive Biblical commentary and communication via the Internet. As applied to the broader category of literary works, the present invention provides a method of interactively delivering editorial content linked with a literary work.

The preferred embodiment methods of the present invention are implemented using known communications networks, such as local area networks (LANs) and wide area networks (WANs). The one used in presently preferred embodiments is the Internet and its Web 2.0 concepts and abilities.

A user of the present invention needs a user communication device that connects to the Internet for the preferred embodiments. Such connection can be via a wired or a wireless interface to the Internet or a service provider through which Internet access is obtained (e.g., dial-up, cable, satellite, WiFi). “User communication device” is any suitable apparatus—from a system of discrete components to a single unit apparatus. In preferred embodiments this is typically any such device from a personal computer (whether Microsoft or Apple operating system based, or otherwise; and whether desktop, laptop or otherwise) to a handheld Internet communication apparatus (e.g., Apple iPhone 3G device). Of whatever specific type, the user communication device for implementing the preferred embodiments of the present invention includes a display screen and a Web browser (e.g., Microsoft Internet Explorer, Apple Safari) and the processing capability of using them to communicate over the Internet. Such communication with the Internet typically occurs remotely from the situs of the website to be accessed.

The situs of the website used in preferred implementations of the present invention includes an information maintenance device, which comprises one or more apparatus capable of providing the control and storage functions needed for implementing network communication capabilities. Typically such an information maintenance device is implemented by one or more servers with accompanying computer memory having operating speed and storage capacity sufficient to handle the amount of information flow coming into, going out from, and occurring within the information maintenance device. Such equipment may be located at one physical site or at distributed locations on the network.

Operating systems and applications are any suitable types as known in the art for implementing the features of the present invention. Non-limiting examples include Microsoft and Apple operating systems and applications; other non-limiting examples include ones using Unix, Linux, or Java programming. Also, the protocols necessary for communicating over a particular network are of any suitable type known in the art (e.g., known Internet protocols such as http/https).

A particular implementation of the information maintenance device includes: commercial grade servers, Linux operating system, Lighttpd, Memcached, Niginx, PostgreSQL, PHP, HTML embedded scripting language, and JavaScript frameworks, including Prototype/Scriptacolus.

Communication connections used to implement the present invention can be wired or wireless types of connections.

As used herein, various terms are to be interpreted in the context and environment within which the present invention is used and as known to those skilled in the art. For example, the material and editorial content as used within the invention are in suitable electronic format (e.g., encoded digital signals); a mouse refers to any component of the user's communication device used for moving a cursor on a screen; a click(ing) is the action of selecting from the screen where the cursor has been placed using the mouse; and graphical interface refers to a hot spot or other area of the screen that represents a choice, option, action, etc. to be taken if clicked on. These are not to be limited to any particular structure, but are used to encompass the variety of ways for implementing the respective functions.

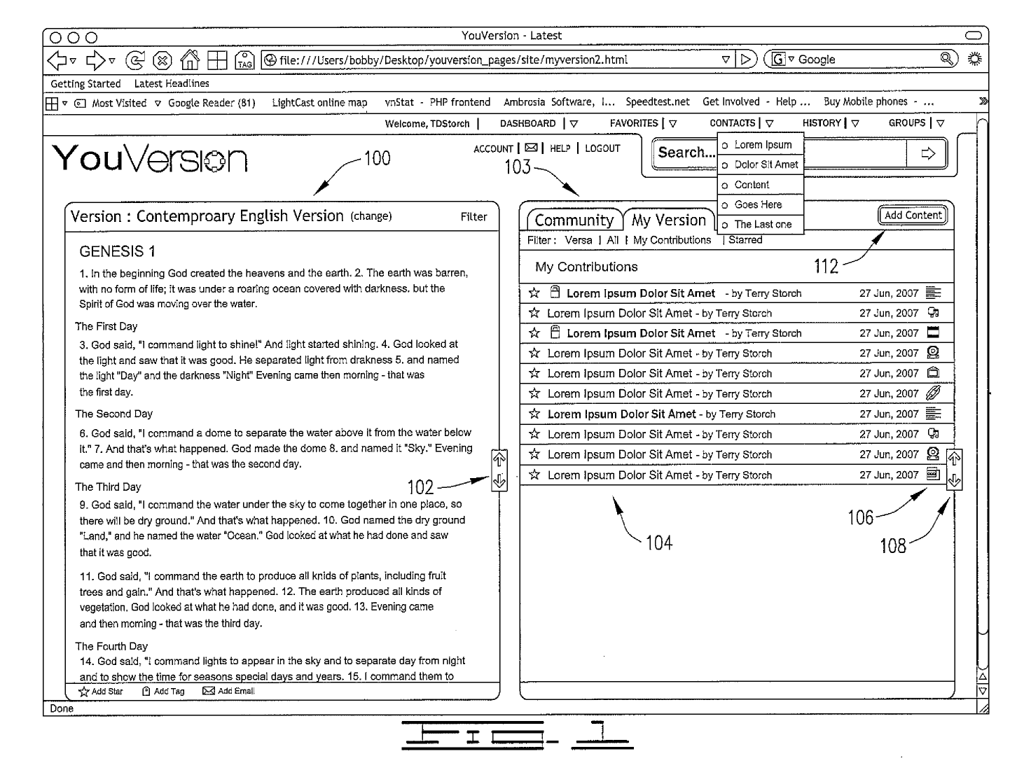

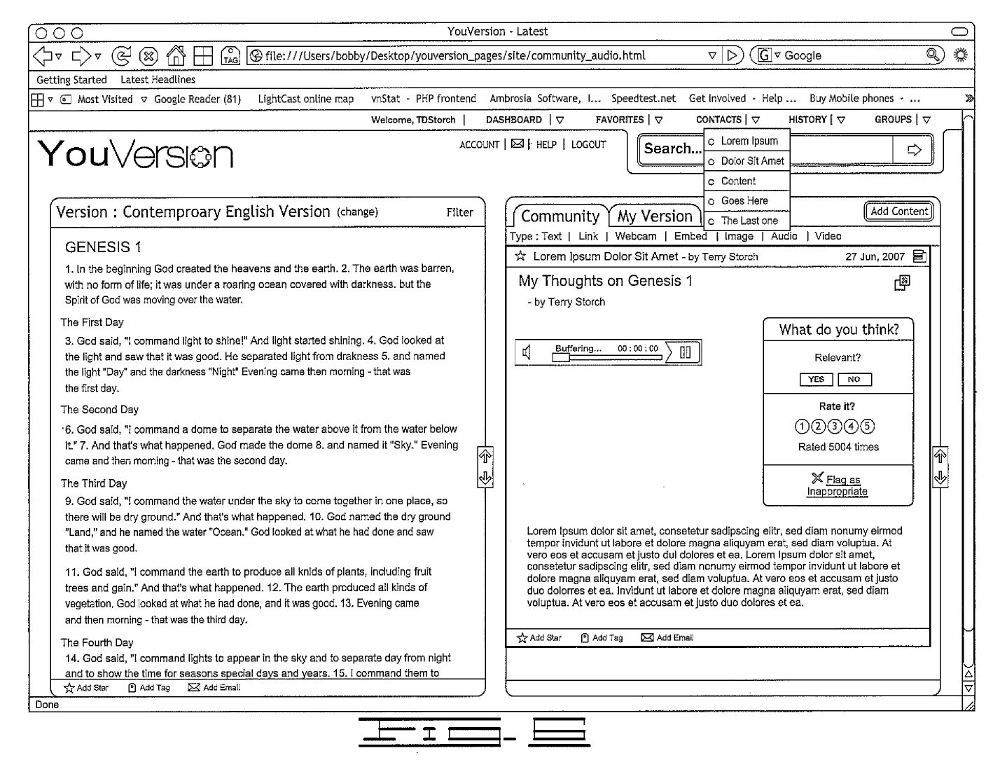

FIG. 1 represents a screen capture of a personal webpage showing material and a list of tags identifying editorial content where the personal version, “My Version,” is selected to display only the tags for the particular user (in the illustrated implementation a tag is a user-input label for the editorial content; see FIG. 6). The type of editorial content file added for a particular Bible verse is shown by icon. Unread comments to the tags are bolded in FIG. 1.

More particularly referring to FIG. 1, a user accesses from the user's computer a website communicating with memory having material, such as literary work, for example, and editorial content digitally stored therein, and displays at least a portion of the material on a screen of the user's computer. In the embodiment illustrated in FIG. 1, the transmitted material is displayed in an area 100 (typically referred to as a window) of the display screen, wherein such area 100 is less than the maximum area of the display screen such that a split screen window can be provided. In a preferred embodiment the material is scrollable using a scroll graphical interface 102 and a mouse of the user's computer. Using a mouse of the user's computer, the user clicks on a segment (that is, some portion less than the whole) of the displayed material such that a selection signal is transmitted to the website for identifying the segment selected by the user.

In response to the transmitted selection signal activating transmission from the website memory, there is displayed, on the user's computer screen in an area 103 in conjunction with at least the displayed segment selected by the user, a list 104 of editorial content (specifically the tags thereof) linked to the identified segment of the literary work. Such displaying of list 104 of editorial content includes showing on the user's computer screen for each entry in the list an icon 106 identifying the media type of the respective entry. These media types include at least one of audio, video, and image. Using the mouse of the user's computer, the user clicks on an entry in the displayed list of editorial content such that an indicator signal is transmitted to the website indicating the user's choice of editorial content to be received at the user's computer. If the list contains more entries than can be displayed in the window, the user can scroll to other entries using scroll graphical interface 108.

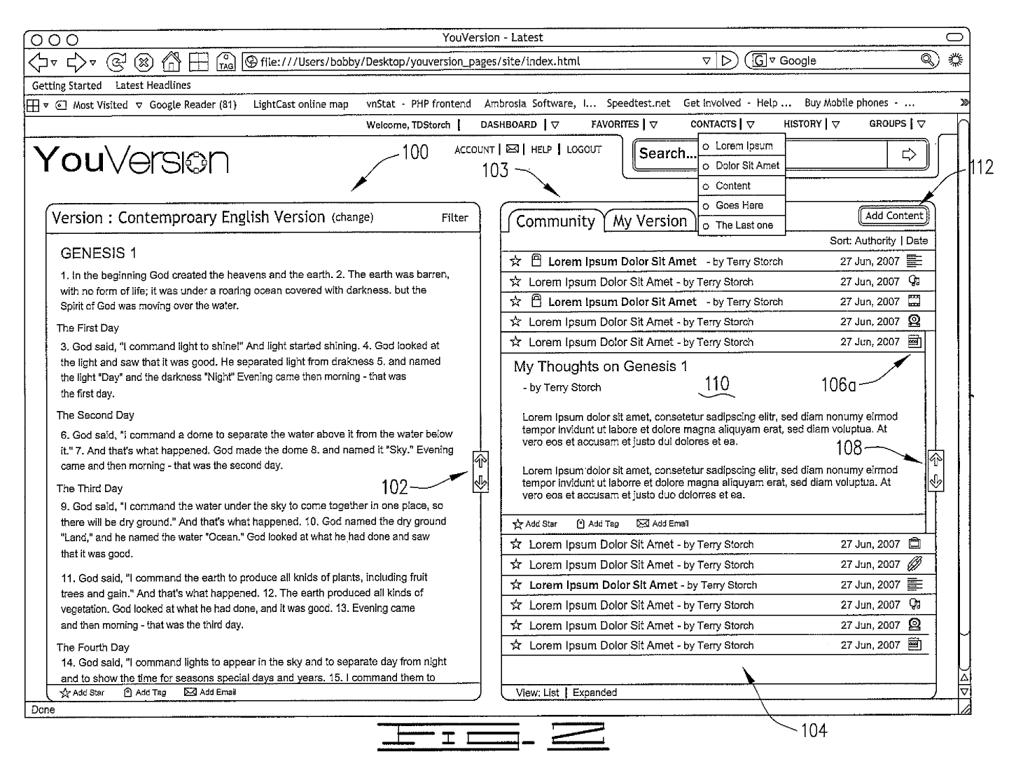

FIG. 2 represents a screen capture where a particular tag is expanded within the overall list to show the underlying editorial content. The list of tags for the particular user is displayed with a selected tag shown in an open, indexed mode. Unread comments to the tags are bolded. The ability to email the author or add an email to the tag is presented.

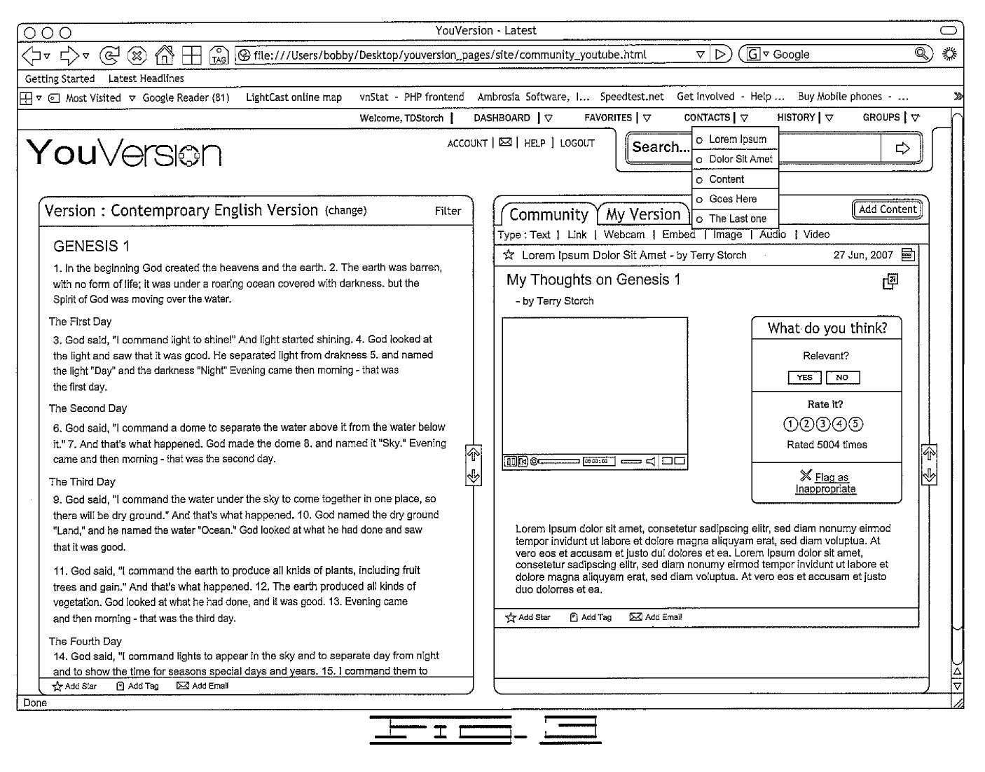

More particularly referring to FIG. 2, in response to the transmitted indicator signal activating website action, there is displayed, on the user's computer screen in conjunction with at least the displayed segment selected by the user and within the displayed list of editorial content, the chosen editorial content 110 (including in this illustration text). As shown in FIG. 2, the transmitted editorial content 110 is displayed on the display screen in area 103 in juxtaposition with the transmitted material displayed in the first-mentioned area 100 of the display screen. In the illustrated embodiment, displaying the chosen editorial content includes showing on the user's computer screen the icon identifying the media type of the chosen editorial content (see icon 106a in FIG. 2). In this preferred embodiment, the user can close the displayed chosen editorial content by clicking, using the mouse of the user's computer, on the icon shown for the chosen editorial content. FIG. 2 illustrates a text-only editorial content expanded within the overall editorial content list. Expanded editorial content having other media are illustrated in FIGS. 3-6.

FIG. 3 represents a screen capture of a personal webpage of tags for the personal version, “Community,” where video editorial content has been selected for a particular Bible verse. This illustrated video selection also includes text, but it need not. A feedback box is shown with a relevance input of yes or no, a rating input from 1 to 5, the number of times it was rated and an input function as to whether the material should be flagged as inappropriate. A user can add a tag, a star or an email to the file through the screen.

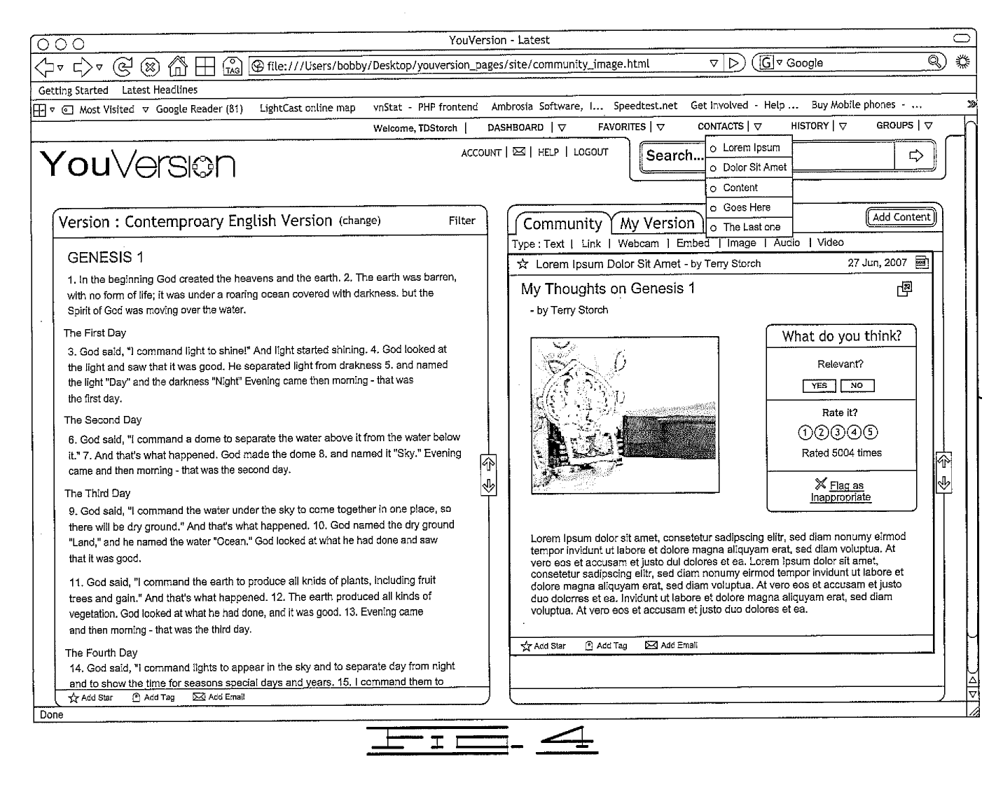

FIG. 4 represents a screen capture of a personal webpage of tags for the personal version, “Community,” where image (e.g., graphic, photographic) editorial content been selected for a particular Bible verse. This selection also is shown with text, but image editorial content need not have text. A feedback box is shown with a relevance input of yes or no, a rating input from 1 to 5, the number of times it was rated and an input function as to whether the material should be flagged as inappropriate. A user can add a tag, a star or an email to the file through the screen.

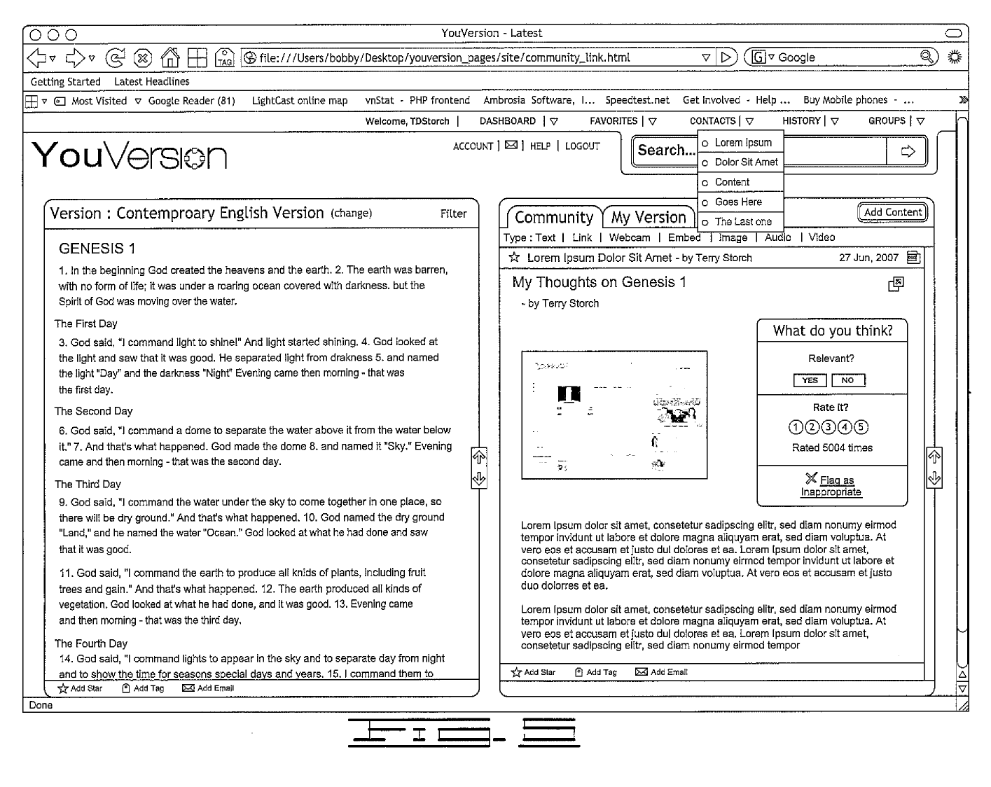

FIG. 5 represents a screen capture of a personal webpage of tags for the personal version, “Community,” where a URL link editorial content has been selected for a particular Bible verse. Text is also shown as part of the URL-link editorial content, but it need not be included. A feedback box is shown with a relevance input of yes or no, a rating input from 1 to 5, the number of times it was rated and an input function as to whether the material should be flagged as inappropriate. A user can add a tag, a star or an email to the file through the screen.

The foregoing comments about FIGS. 3-5 also apply to FIG. 6 except that FIG. 6 shows an audio editorial content selection having been made.

Using the same steps as described with FIGS. 1 and 2, the user can further operate the mouse of the user's computer to click on another entry in the displayed list of editorial content such that another indicator signal is transmitted to the website indicating the user's additional choice of editorial content to be received at the user's computer. In response to this additional indicator signal being transmitted and activating website action, there is at least scrollably displayed (e.g., using the graphical interface 108 and the mouse), on the user's computer screen in conjunction with at least the displayed segment selected by the user and within the displayed list of editorial content, the additional chosen editorial content.

Referring to FIG. 1, the user can add to the editorial content in the website's memory, such as by initially clicking on the “add content button” 112. Adding to the editorial content includes transmitting user-defined editorial content from the user's computer to the website, wherein the user-defined editorial content contains any of the media types including audio, video, and image, in addition to text.

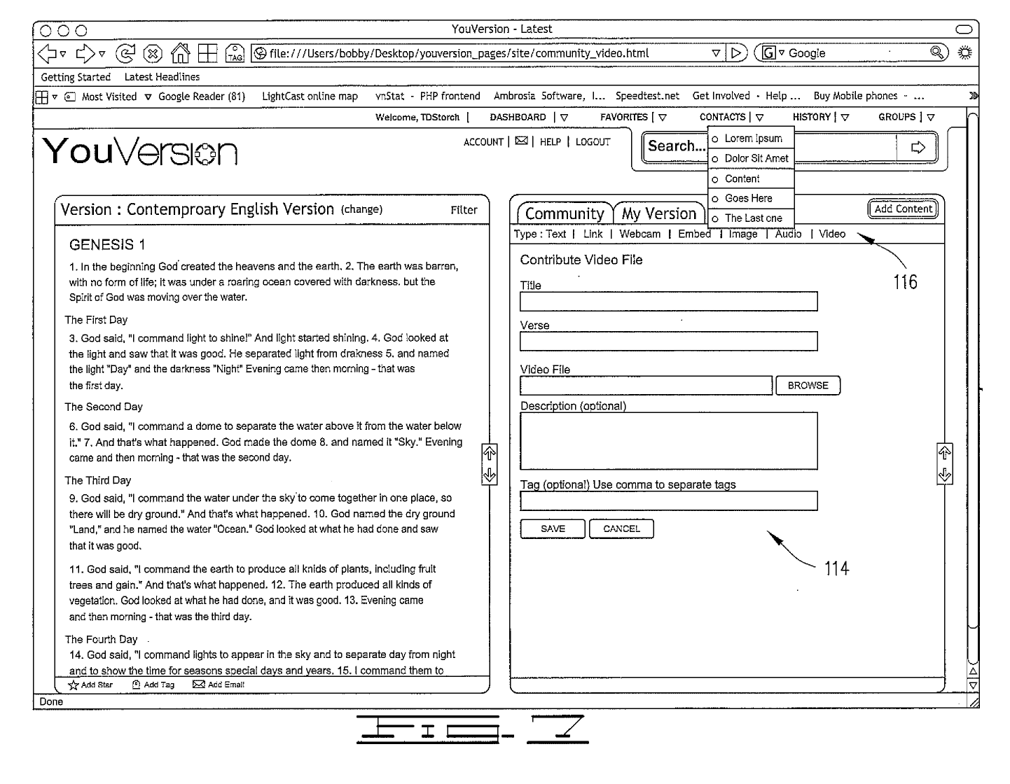

FIG. 7 illustrates how specific editorial content is added once the “add content” operation is entered. FIG. 7 represents a screen capture of a contributing video input screen having dialog boxes 114 for entering the title of the video, the particular Bible verse(s), the video file with a browse feature, an optional description and an optional searchable tag. The user simply puts the appropriate entries in the dialog boxes 114 that pop up when the user indicates the type of media by clicking on the appropriate one of selector icons 116. This particular one shown in FIG. 6 is for a video file to be entered. Similar dialog boxes are used for the other types of media. For example, to contribute an image file, the same boxes are used as in FIG. 6 except an “image file” box replaces the “video file” box. For embed code (e.g., YouTube, HTML-based video) an “embed code” box is used in place of the “video file” box. To link to a URL, a “URL link” box is used instead of the “video file” box. To link to audio an audio file input box is used. For text, only the title, verse, description and tag boxes are used in this illustrated implementation.

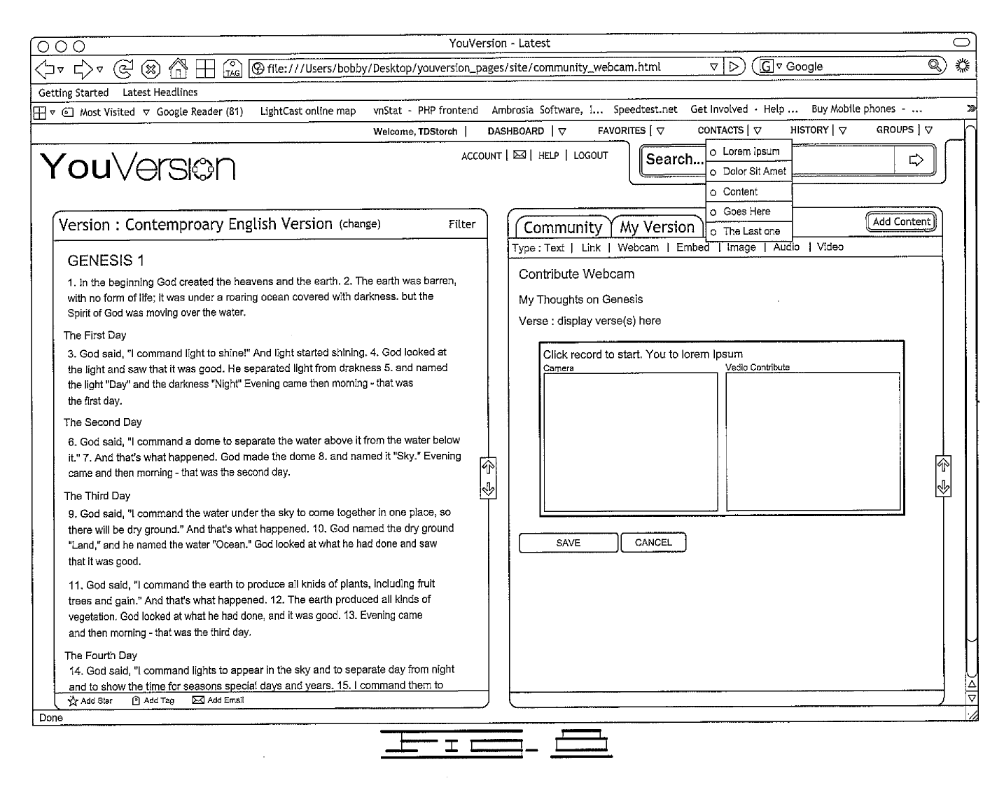

If a webcam (or other external camera) is used to directly produce video, another window opens after entering title, verse and optional description and tag information. This other window, via which the video is uploaded, is illustrated in FIG. 8. In this illustration FIG. 8 specifically represents a screen capture of a contributing webcam input screen for displaying the webcam video feed being entered. The Bible verse(s) again being shown as a split screen window.

In a particular implementation of the present invention, a user can, in adding to the editorial content, define within the transmitted user-defined editorial content access permission data designating any limit to access of such user-defined editorial content from the website. Such access control data is associated with the editorial content data transmitted by the user. To accomplish this, the user is asked to “Choose Your Privacy Settings” when submitting content. In the illustrated implementation, the default is “Public,” but the user has the option to make the contribution “Private.”

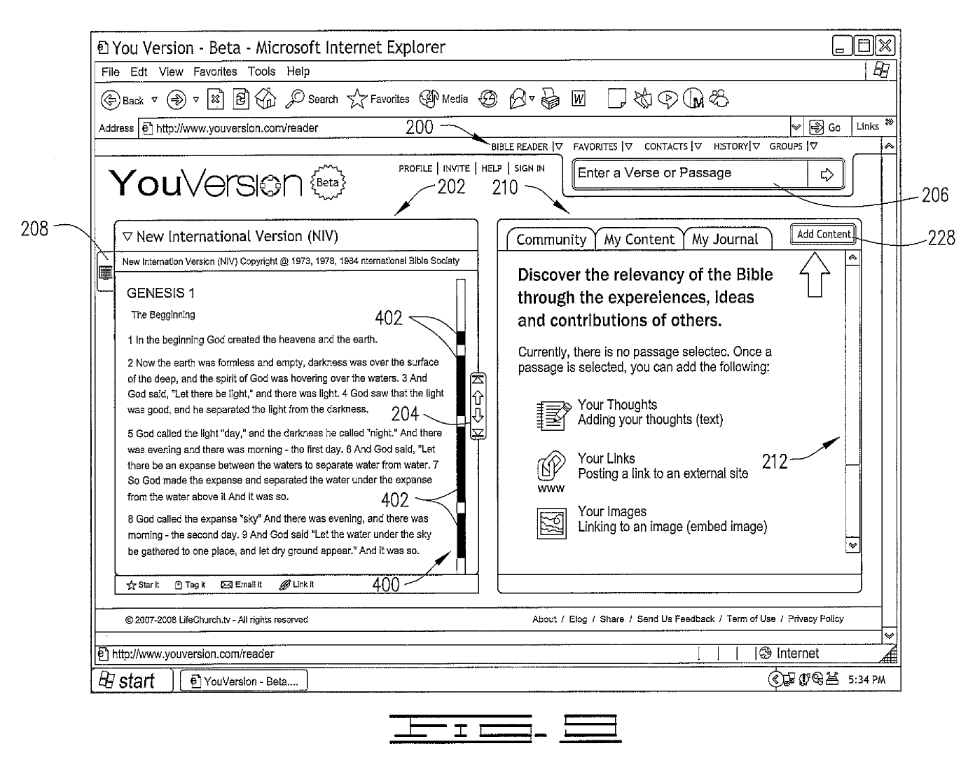

A current implementation of the foregoing is illustrated in FIGS. 9-12. The website accessed is www.youversion.com (YouVersion is a trademark of Life Covenant Church, Inc.). From the accessed webpage, the user clicks on the “Bible Reader button” 200 to retrieve the material, which in this implementation is a version of the Bible. An initial portion of the Bible is displayed in area/window 202 and is scrollable using scroll graphical interface 204 as shown in FIG. 9. A different portion of the Bible can be accessed using either text search window 206 or table of contents icon 208 (clicking on this icon opens a scrollable table of contents window). Since at this point no specific part of the work has been selected, the editorial content area/window 210 is displayed but with predetermined information displayed. This is scrollable using scroll bar 212 and the user's computer mouse.

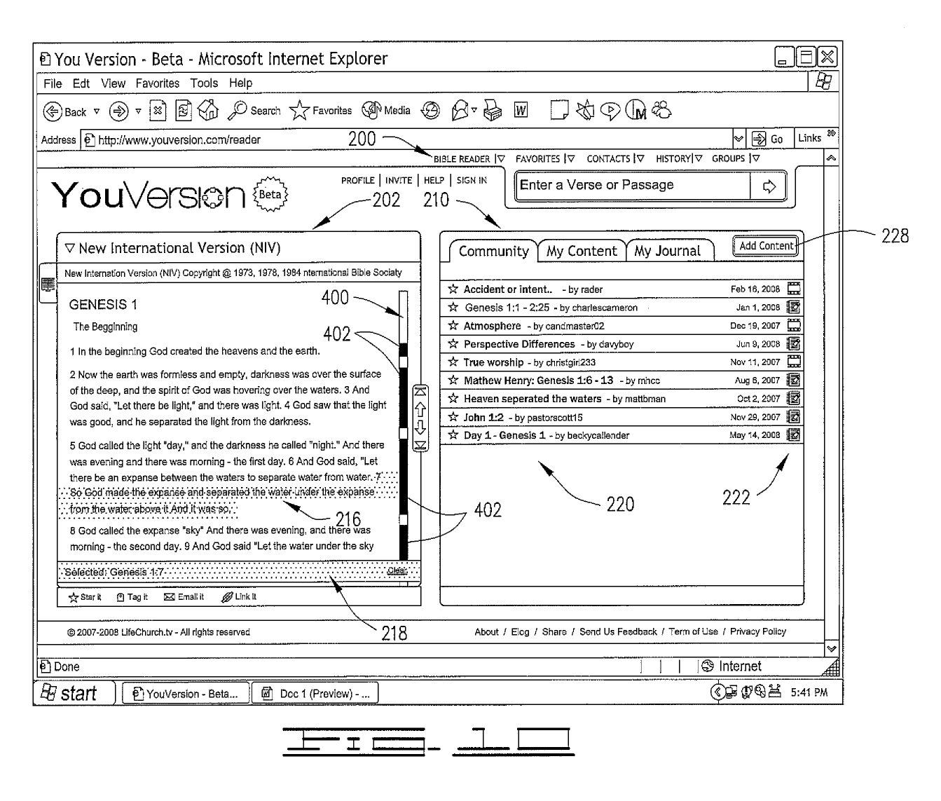

In this illustration the user selects Genesis 1 and so retrieves what was originally shown in FIG. 9 and now shown in FIG. 10. Using the mouse the user selects a displayed portion of the material; in this illustration verse 7 of chapter 1 of Genesis is selected as indicated by highlighting 216. The selected portion is also identified near the bottom of window as shown in selection identifier area 218.

In response to the website receiving this selection signal, a list 220 of associated editorial content is sent to the user for display in window 210. This list includes labeling provided by the respective user who added the editorial content, and the website program appends the appropriate media icons 222 to the content entries.

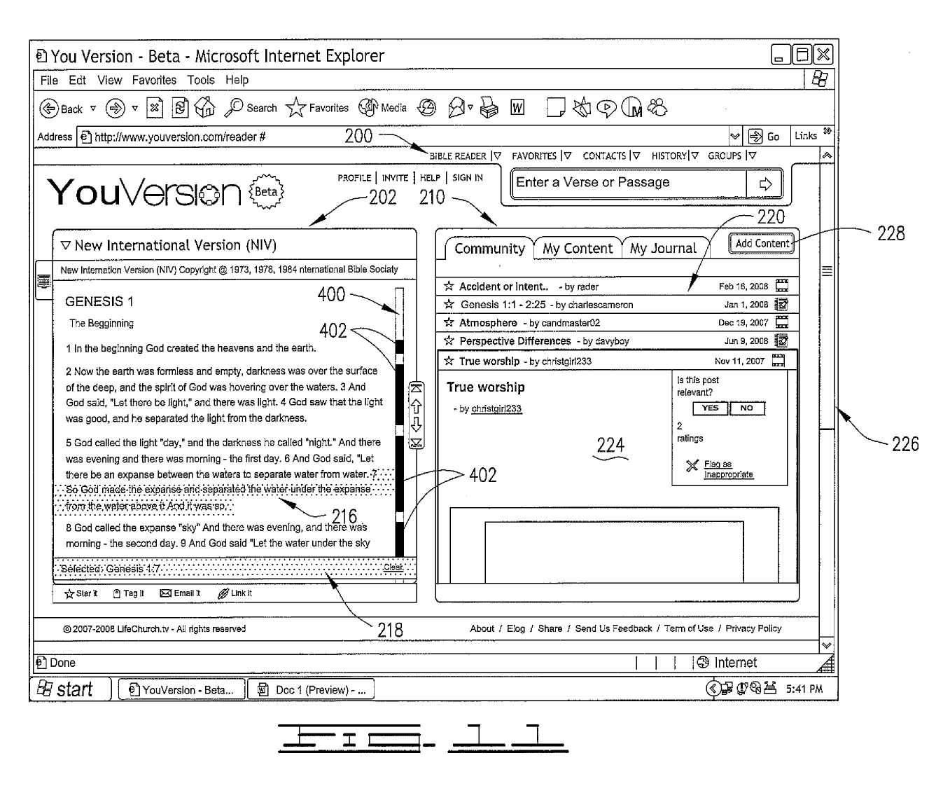

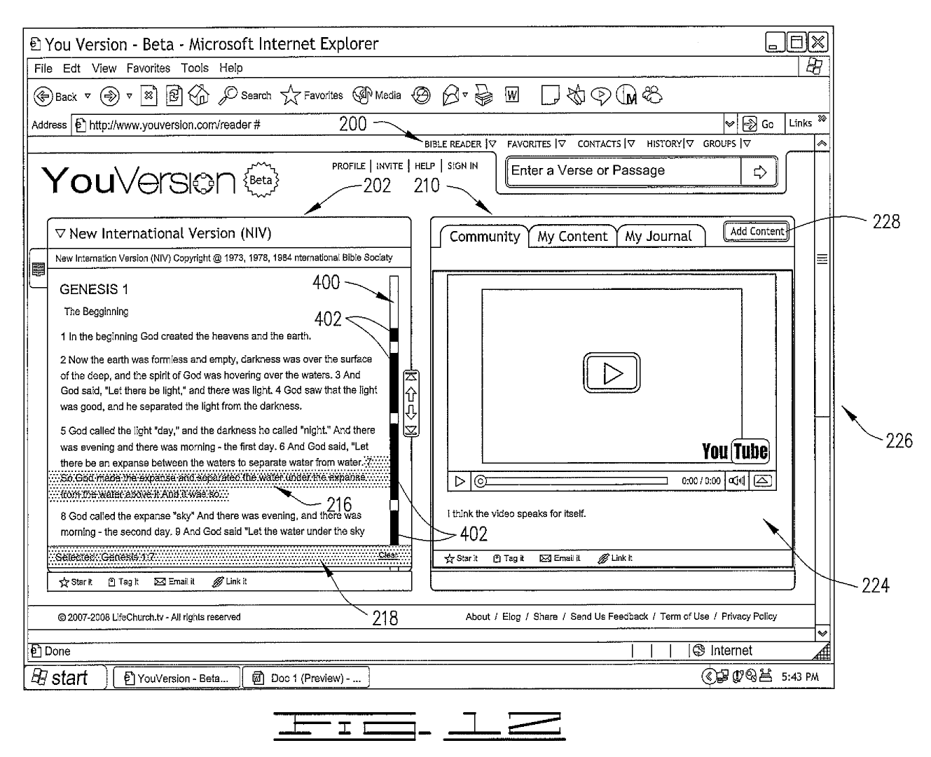

To retrieve the actual editorial content, the user clicks on the entry that the user chooses. In this illustration, the “true worship” entry is chosen. This indicator signal is transmitted to the website, which returns the requested editorial content as shown in FIG. 11 as labeled with reference numeral 224. As shown in FIG. 11, this content is displayed in juxtaposition with the selected text 216 of the material in window 202 and also at its place within the overall list 220 of editorial content associated with the selected material. This list 220 remains scrollable via scroll graphical interface 226 so that the user can move through the list 220 and the retrieved editorial content 224 as shown in FIG. 12.

As previously explained the user can add editorial content. In the particular implementation of FIGS. 9-12, Content can be added by clicking on the “add content button” 228. This opens a login window through, which the user can login if previously registered or he/she can create an account if not previously registered. Upon logging in or registering, additions can be made as explained elsewhere herein.

From the perspective of the website, the foregoing can be described in various ways, each implemented by suitable programming in the server(s) or other computer equipment defining the website to be accessed by a user. In one way, the present invention is defined as a method for electronically providing material to a user such that the user can at least receive editorial content linked to a selectable portion of the material. This method comprises transmitting material over a communication network to a user and receiving over the communication network a selection signal responsive to the user selecting a portion of the material transmitted to the user. This method also includes transmitting over the communication network to the user editorial content previously linked by other users to the same selected portion of the transmitted material, wherein at least part of the editorial content includes at least one of audio, video, and image media. In a preferred implementation the transmitted material is displayed in an area of a display screen being used by the user in communicating with the communication network, wherein such area is less than the maximum area of the display screen. This allows the transmitted editorial content to be displayed on another area of the display screen in juxtaposition with the transmitted material displayed in the first-mentioned area of the display screen.

This method can further comprise receiving over the communication network editorial content data transmitted by the user and related to the selected portion of the material. This editorial content data includes audio, video or image media. In a particular implementation the method specifically includes receiving over the communication network editorial content that includes digitally encoded video that the user has linked to the selected portion of the transmitted material; this method further includes storing, in memory connected to the communication network, a form of the editorial content such that the user or other users of the communication network can later access the editorial content responsive to any such user selecting the portion of the material over the communication network. Storing a form of the editorial content can include identifying from the user's input into the communication network whether that user's editorial content is to be accessible by other users or only said user. That is, in adding editorial content, the method can further comprise receiving over the communication network access control data associated with the editorial content data transmitted by the user.

A more specific definition of the present invention is as a method for enabling interactive Biblical commentary and communication via the Internet, wherein Biblical commentary and communication information is stored in computer memory and retrievable therefrom via the Internet and wherein a user has a communication device which includes a display screen and which communicates with the Internet remotely from said computer memory. This method comprises: in response to a command signal transmitted over the Internet from the user's communication device, transmitting over the Internet to the user's communication device a portion of an electronic version of the Bible included in the Biblical commentary and communication information such that the transmitted portion is at least scrollably visible by the user viewing the display screen. In response to a selection signal transmitted over the Internet from the user's communication device selecting a verse of the viewed portion, the method transmits to the user a list of linked content included in the Biblical commentary and communication information and stored in said computer memory as related to the selected verse, the linked content including at least one digitally encoded video and having been input into said computer memory in response to at least one other user transmitting such linked content for storing in said computer memory. In response to an indicator signal from the user indicating a choice from the list of linked content, the method transmits to the user the chosen linked content and causes the chosen linked content to be displayed on the display screen with the selected verse. This method can further comprise receiving over the Internet user-submitted content transmitted by the present user and related to the selected verse, said user-submitted content including at least one of audio, video, and image media. Relatedly, the method can further comprise receiving over the Internet access control data associated with the user-submitted content transmitted by the user.

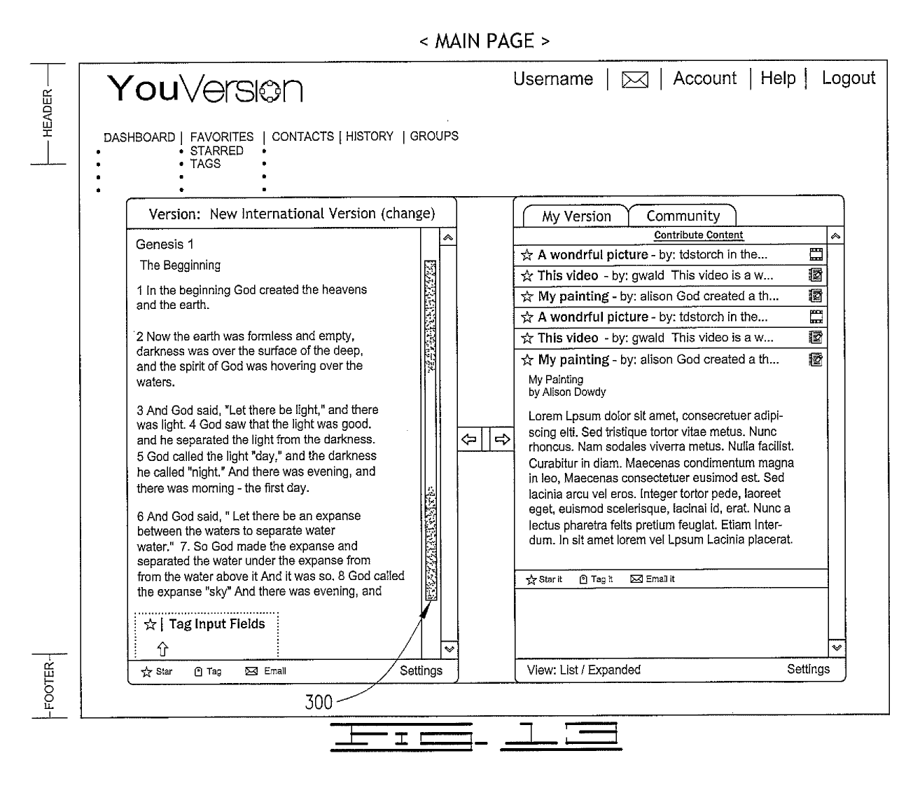

Another feature of the present invention includes indicating to a user at least relative amounts of editorial content that have been linked to respective portions of the displayed material. This is illustrated in FIG. 13 as indicia 300. Although the indicia can be represented in any suitable manner and to designate actual amounts of editorial content (e.g., specific number of items in the related editorial content list), in the illustrated implementation relative amounts are indicated. This is implemented by transmitting, in association with the displayed Bible portions for the present illustration, the indicia 300 representing to the user at least relative amounts of editorial content linked with selectable portions of the transmitted material. In a particular implementation this includes transmitting data signals defining the indicia on the display screen as a graphical interface of different color intensities based on the respective amounts of editorial content linked with the displayed selectable portions of the material. The graphical interface in the FIG. 13 implementation specifically includes a vertical ribbon having gray-scale bars 302 (from white to black at the extremes) displayed on the display screen adjacent respective portions of the displayed material. Thus, the graphical interface displayed is based on the respective amount of editorial content linked with the displayed, selectable portions of the material. In FIG. 13 the gray-scale bars 302 have their color varied as the amount of editorial content linked with the displayed portion of the material changes (such as the number of editorial content contributions). It is contemplated that other indicia can be used as well, such as a color scale (other than gray-scale), a numerical scale, an alphabetical scale, or combinations thereof.

The foregoing is implemented in the methods represented in FIGS. 9-12 in which the same implementation of indicia 400 as gray-scale bars 402 is shown.

Accordingly, the present invention also provides a method for electronically providing material to a user such that the user can at least receive editorial content linked to a selectable portion of the material, comprising: transmitting material over a communication network to a user such that the material is displayed on a display screen used by the user, wherein the transmitted material includes selectable portions with which editorial content is linked; and transmitting, in association with the material for display on the display screen with the material, indicia representing to the user at least relative amounts of editorial content linked with selectable portions of the transmitted material. In a particular implementation, transmitting indicia includes transmitting data signals defining the indicia on the display screen as a graphical user interface of different color intensities based on the respective amounts of editorial content linked with the displayed selectable portions of the material. In a more specific implementation, the graphical user interface is a vertical ribbon having gray-scale bars displayed on the display screen adjacent respective portions of the displayed material.

This aspect of the present invention can also be stated as a method of interactively delivering editorial content linked with a literary work, comprising: accessing from a user's computer a website communicating with memory having literary work and editorial content digitally stored therein; displaying a portion of the literary work on a screen of the user's computer; and displaying, on the screen in association with the displayed portion of the literary work, indicia representing at least a relative amount of editorial content linked with the displayed portion of the literary work. In a particular implementation, displaying indicia includes displaying a graphical user interface based on the respective amount of editorial content linked with the displayed portion of the material. In a more specific implementation, displaying a graphical user interface includes displaying a vertical ribbon having a color bar on the screen adjacent the respective portion of the displayed material, including varying the color of the bar as the amount of editorial content linked with the displayed portion of the material changes.

Although not necessary for implementing the present invention itself, the following are examples of other features that might be included in a website where the present invention is implemented: a webpage login screen with a username and password entry field; an interactive link for those who forget their password; an interactive link for those who desire to create an account; an interactive submission button; an interactive link for a privacy policy and an interactive box indicating that a new user agrees to the privacy policy; a screen wherein a user is able to choose a username, enter their real name, gender, postal address, and email address, select a password and confirm the entered password; an anti-data mining image verification captcha entry; an interactive link for the website terms and conditions and an interactive box indicating a new user agrees to the terms and conditions; a webpage indicating success on creating a new account; a user's profile saved on the server; the ability for a user to view and edit the profile and personal webpage; a screen displaying the user's name, the number of items they have submitted, rated or tagged; the ability to update their personal image on the server by browsing for it on their local computer or searching for it; the ability to reset the image to a default; a key word search function; personal webpages about sent and received emails (including a deletion capability) and the ability to switch between the inbox and the sent box; and the ability to compose an email.

Additional support for the foregoing is set forth in the following information taken from the referenced provisional applications. Other portions thereof are incorporated herein by reference. The following references to “YouVersion” are as the trademark and website under which and through which a particular implementation of the present invention is provided.

YouVersion^{beta} 1.01 Scope
Your life. Your friends. Your Bible. All connected.
YouVersion
The Bible is not lifeless . . . why read it that way? YouVersion is a complete online Bible that enables community and relevant collaboration like never before. With YouVersion, you will read the Bible in a new light while taking interactive notes, uploading relevant video, images and other interactive media, and it doesn't stop there! With YouVersion, you also have the ability to engage with others and learn from their insights, thoughts and unique perspectives. Our lives are complicated enough . . . YouVersion provides a simple and easy to understand approach to studying God's Word. Connect now and experience a life-changing message like never before.

YouVersion>Dashboard
Goal
   Lead users into areas in situations where they might not know where to start or what they are looking for by bringing relevant, important, and new content forward to the dashboard area.
Layout
   In a widget layout, users can control what they see, they can add custom widgets built from the feeds they've subscribed to, add new YouVersion tools as they are released. Certain elements of the dashboard will be locked and not editable, these are not widgets.
“Return to Last Bible Study”
   This builds on a functionality that is later discussed in the user section of being able to return a user to where they last were in the Bible and their contributed content. This widget will be one of the non-editable types.
“What's Hot?”
   Shows top verses being discussed based on an algorithm that will consider views, 5-star ranking, number of contributions on verse (with more recent contributions being weighted heavier than older contributions), and current users viewing the verse.
Seasonal Stories
   Feature stories based on the current season, i.e. Christmas, Easter, etc.
Widgets
   Custom “Top” List
      User can customize this widget to display “Last Talked About” which would be more time-submitted focused, and possibly by ranking alone which would be “Top Ranked” (taking into consideration a minimum number of votes.)
   News
      Wrap relevant YouVersion content around current news to draw users in to start contributing. (ex: Virginia Tech tragedy, let users express what parts of the Bible are speaking to them about that story.)
   New Believer and Apologetics areas
   Your Feeds
      User can add feeds built off of another user's content, feeds built from tags, etc to a widget area on the dashboard.

YouVersion>Users
Interaction with other users
   Friends and Family Lists
      Determines what users can see you have contributed to YouVersion. Example: You may contribute something that only your family members can read.
   Private Messages (email within the YouVersion system)
   Subscribe to other users'content through RSS feeds and email subscriptions
Contributing to YouVersion
   Ways to contribute to YouVersion: add notes, add media, tag content, link to outside resource, and mass uploading/queuing (more about this below.)
   Taking notes on the Bible, marking these as public, private, friends or family.
      Ability to group notes together to form a “personal sermon.”
   Adding media (audio, video, images, etc) to YouVersion either as attachments to notes that you have written or as stand alone media assets.
   Provide clear and easy ways for users to start contributing to YouVersion . . . flowing. Provide methods for users to replicate content from their own blog, website, etc over into YouVersion so that they don't have to duplicate content in two areas. Possibly provide plugins for the top blog engines.
Interacting with YouVersion
   “Voting” on whether a user contribution was helpful or not helpful through the use of a “5-star” system.
   Users can mark user contributed content as spam, after a determined number of flags for spam by users (2), the content is sent to the YouVersion administrators for final determination.
   Users can spend time in the media queue's and tag content that has been “mass-uploaded” by other accounts to get it into the system.
   YouVersion Search History will allow users to see what they searched for, where they have been, when they were there, you will be able to “star” content to put into your “favorites” list. This history functionality will also constantly keep track of where a user currently is so that a user can quickly return to where they were studying the Bible when returning to the site.
Viral/Social Tools and YouVersion
   Provide all the necessary tools for users to spread the YouVersion content to the internet.
   Allow users to adjust account settings for the viral/social tools that they use with the goal being that we have all of the tools available, but only show the one's that specific user wants to use.
   Provide “Email This” functionality on all relevant aspects of YouVersion, wherever it should and needs to be spread, provide this.
   Ability to subscribe to all sorts of content, both through RSS feeds and email subscriptions.
Account
   Profile
      User controls what information in their profile is public and private. When a user first sets up their account, look out to other popular sites to gather some core account info/profile photo, etc.
   Settings
      Time zone, default search settings, social spread tool preferences, default contribution preferences (ex: public/private), Bible version, one or two column layouts, etc.
Mass Media Providers (*special accounts, aka Media Leeching)
   Mass upload
      Allow certain approved user accounts the ability to mass upload a list/feed of media assets for possible consideration into YouVersion.
      The media assets then can be tagged and noted by users that will then be brought into the YouVersion system.

YouVersion>Bible (Study, name undecided)
Contributing
   User can contribute to YouVersion by adding notes, videos, photos, audio and links to Bible verses.
   Ability to “highlight” a verse (or multiple verses) and then contribute based on the verses that were chosen.
   Designate the contribution as public, private, friends, or family.
   Build a group of contributions into a collection as a “personal sermon” with the ability to later push the entire “personal sermon” as public, private, friends or family.
Reading the Bible
   On the fly, your notes or user contributed (community) notes will load in the other pane.
   Users can “vote” on community notes in a 5-star type rating system whether the note was helpful (relevant) or not helpful (relevant).
   Built-in spam tools for users to flag notes as spam/junk. If a note has been flagged a designated number of times (2) then it is automatically sent to the administrative queue where an administrator decides the next step.
   Be able to “star” notes and verses so that you can later reference it in your favorites list.
   “Link Creator” functionality that allows you to email or send to someone on your friends/family list the exact location you are in the Bible and the notes area. This will allow direct linking to exactly where you are located in all parts of the interface. Ability to load into dual columns in Bible pane, two different versions of the Bible that will stay linked together as you scroll through the chapters. This will provide a way to compare different versions of the Bible as you take notes.
Interface
   Two-panel layout split 50/50, with the ability to adjust the width of the panes. Bible content can be viewed in a wide layout that will run the text the width of the pane, or in what we call a “two-column” sized layout where it presents a more narrow column similar to what a person would be used to reading in an actual Bible.
   Content in panes will have continuous scroll that is always loading in content so that there is never a “next” button/link needed.
   The pane on the left is the focused pane, so if you are studying the Bible you will scroll through the chapter, as you do the right pane will continuously load in the related notes (either your notes or community depending on the tab you're on.) If you are studying someone's collection of notes (“personal sermon”), it will be on the left and the Bible on the right. As you scroll through the “personal sermon” it will bring in the associated verses in the right pane.
   In the Bible-focused layout (Bible in left pane), the notes on the right will have the option of being represented in two ways, an expanded view or list view. Expanded view will have all the notes open showing both the title/date/author of the note along with the content of the note, while the list view will just show the title/date/author info. In the list view, the user will click on the title/date/author bar and the note will open up.
   Interface illustrations are shown in the drawings.

YouVersion>Global Features
Smart. Search
   Help users by providing alternative search terms, synonyms and misspellings. Keep history of search results. (read more about this in the YouVersion Search History on the user page)
   Provide popup of suggested searches based on what the user is typing in; build this list from the database of previous user searches as well as from the user's own search history.
   Ability to limit search to certain items, like just items tagged with certain terms, within just a certain user's content, date ranges or search user content that's tied to only certain verses or books.
   Keyword search in the Bible and user contributed notes, be able to limit just to one or the other if needed.
   Ability to search within just content you've starred (favorites).
Top Navigation
   User Name (email)
   My Account
      History
      Settings
      Profile
   Help

YouVersion>Administration Control Panel
Tools
   Efficient/easy moderating of content that has been posted to the site and marked as spam/questionable.
   Ability to ban users based on IP, user name, email, etc.
   Adding/modifying/archiving of channels, topical areas, seasonal content, etc.
Communication/Tips & Tricks Blog
   Add entries to the dashboard communication/tips and tricks blog.
   Build scheduled blog entries.
   Capability for the system to post a tip or trick at “random” if no blog entries have been entered.
Statistics Console
   Extensive usage breakdowns
   Charts and graphs
   Geographical and time information
   Ability to export into reports, CSV, etc.

YouVersion>Groups
Goal
   Bring users together in YouVersion to collaborate, create, share, and fellowship online through the use of email, instant messaging, blogs, chat, and discussion boards.
What is a group in YouVersion?
   Two or more users joining together.
Group Features:
   Custom group web page
      Discussion board
         Subscription: RSS feed, email
      Collaborative “personal sermons”
         Subscription: RSS feed, email
   Ability to merge with another group, combining content, etc.
   Categories
      Groups can categorize their focus/genre (i.e. Married, Singles, etc)
   Group Studies
      Chat
         Archived
      Study the Bible, “personal sermons” built from users/groups, apologetics, topical content
         “Highlighter” function that allows users to pass control of the “push” content to other users in the group so that they can “talk”
         “Push” control is by the group leader by default, or whoever the “highlighter” has been passed to.
      Calendar
         Setup meeting times
         Auto-reminders to users in the group (customizable by each user)
         Subscription: RSS feed, email
   Part of a larger Group
      Groups can be a part of a larger group: the idea that a church could setup a group and then have members within that church setup their small groups within that church so that they are all associated. This will be even more important when/if there is an API.
   New users joining
      Private groups—hidden from view on site, users can be invited by users in the group.
      Public (locked) groups—public can view on the site, users can request to join the group then up for approval by group leader/group users.
      Public (open) groups—public can view, anyone can join without need for approval.
User Features:
   Ability join many groups
   Push their content to the group to be merged as “group content”, maybe group “votes” to have a user's contributed content considered the “groups” content?
      Content can be dynamically linked where the user updates his notes and it will update the version pushed to the group, or copied where the user can continue to update the note but the version that was pushed to the group will remain as the original; but they can be synced back up later.
   Ability to invite users to the group (if it is a private group)
   Lead group(s)
      Control group settings
         Frequency/method of group updates to users in the group
         Joining/approval of users
      Moderate group
      Approval/publishing of user submitted content to/as group content

YouVersion>API
Goal: To further spread the use of YouVersion by enabling other churches (websites) the ability to push/pull data to/from YouVersion in their own environment.
Capabilities:
   Return YouVersion content information through XML API calls
      Create/edit users
      Contribute
      View content
   Limit certain API accounts to certain calls
   Use any platform, any language through the use of an XML API
Approval
   Users must submit an application for approval to use the API
   API privileges can be revoked if user is abusing the system in some way.
Documentation
   Provide extensive documentation on the API
   Provide examples for some languages

YouVersion>Help System
Goal: Provide a top-notch help system to show users how to use the full-depth that YouVersion provides so that they get the most out if it.
Features:
   Top 5 questions asked . . .
   After a question is asked provide the results and some alternative questions. Viewer answer, ability for user to respond whether the answer was useful or not based on the question they asked, use these statistics to drive future search results.
   Provide a list of help topics, index, and glossary/sitemap.
   Help/discussion forum for users to share ideas on how to get videos upload/converted between formats, etc. . . . allow the community to support itself in some way.
   Is the Bible relevant today?
      Does a book written thousands of years ago apply to modern, everyday life? Some people believe Scripture is timeless and have personal experiences of how God uses the Bible to speak truth into any situation. Others question how something so ancient can have any relevancy in the fast changing world in which we live.
      Whether you've been studying the Bible for years or are simply curious about its claims, YouVersion will allow you to read, explore, ask questions and learn from others in a revolutionary new way.
Features:
A revolutionary online Bible that enables community and collaboration like never before. Choose from various translations and read Scripture in a fresh, new way. Take personal study notes, and discover and contribute audio, video, text and images. With YouVersion, you will find communities of people exploring and interacting with God's Word.
Organize
Organize the content that's important to you and bring it front and center. With the ability to tag and star content and Bible verses that resonate with your studies, you can easily refer back to materials you previously viewed and save yourself valuable time.
Share
When you discover something special, you want to tell the world. YouVersion makes it simple to share meaningful content with anyone, anytime, anywhere using easy-to-use tools like email a friend, widgets and RSS feeds.
Community
YouVersion makes it easy to connect with other people and to collaborate with them in new and exciting ways. By utilizing the built-in functionality of YouVersion, you can engage with the YouVersion community as you share your thoughts, feelings and reactions to the Bible.
Contribute
Contribute and associate a video, audio file, image, link, or text commentary to any verse or series of verses in Scripture . . . With YouVersion you have the power to share your content with whomever you choose . . . your closest friends, family, or anyone online!

YouVersion Blog
YouVersion: The Bible meets Web 2.0
by Bobby Gruenewald
Johann Gutenberg invented the printing press in 1450. Four years later, he printed the first copy of the Bible using this new moveable type system. This accomplishment began what is known as “The Age of the Printed Book.” Over the following centuries, this technological advancement revolutionized the surrounding culture by making it possible for the Bible to be accessible to nearly everyone.
Currently, we are in the beginning of another revolution that is defined by the ability for almost anyone to publish content and quickly distribute it worldwide using the Internet. This revolution is at the center of what is called “Web 2.0.”
At LifeChurch.tv, we are working on several initiatives to leverage this revolution in our effort to lead people to become fully devoted followers of Christ. Today, we are revealing one of the most significant and far reaching of those projects:
We'd like to introduce you to YouVersion.
YouVersion is a free online Bible that allows users to associate video, audio, images, text, tags, and links to other websites with any verse or series of verses in the Bible. Each piece of contributed content can be labeled as public or private, so the application can be used both as a personal study tool and a public expression of user-generated commentary. In addition to contributing content, Scripture can be organized by assigning user-defined “tags” to any verse of the Bible.
For users who are skeptical about whether the Bible has application for their lives, YouVersion provides a platform to learn from the experiences and perspectives of others from around the world in a non-threatening and easily navigated environment.
If you have questions or would like to discuss the project you can do so on this post at LifeChurch.tv.swerve. If you'd like to contribute your services and be a part of this project, please contact us here.
In the coming weeks we will post updates on the development of the project here. You can subscribe to the rss feed to stay informed or leave your email address to be notified when we release trial versions.

Thus, the present invention is well adapted to carry out the objects and attain the ends and advantages mentioned above as well as those inherent therein. While preferred embodiments of the invention have been described for the purpose of this disclosure, changes in the construction and arrangement of parts and the performance of steps can be made by those skilled in the art, which changes are encompassed within the spirit of this invention as defined by the appended claims.

What is claimed is:

1. A method for electronically providing material to a user such that the user can at least receive editorial content linked to a selectable portion of the material, comprising:
transmitting material over a communication network to a user;
receiving over the communication network a selection signal responsive to the user selecting a portion of the material transmitted to the user; and
transmitting over the communication network to the user editorial content previously linked by other users to the same selected portion of the transmitted material, wherein at least part of the editorial content includes at least one of audio, video, and image media.

2. A method as defined in claim 1, wherein:
the transmitted material is displayed in an area of a display screen being used by the user in communicating with the communication network, wherein said area is less than the maximum area of the display screen; and
the transmitted editorial content is displayed on another area of the display screen in juxtaposition with the transmitted material displayed in the first-mentioned area of the display screen.

3. A method as defined in claim 1, further comprising receiving over the communication network editorial content data transmitted by the user and related to the selected portion of the material.

4. A method as defined in claim 3, further comprising receiving over the communication network access control data associated with the editorial content data transmitted by the user.

5. A method as defined in claim 1, further comprising transmitting, in association with the material, indicia representing to the user at least relative amounts of editorial content linked with selectable portions of the transmitted material.

6. A method for electronically providing material to a user such that the user can transmit and receive editorial content linked to a selectable portion of the material, comprising:
transmitting material over a communication network to a user;
receiving over the communication network a selection signal responsive to the user selecting a portion of the material transmitted to the user;
receiving over the communication network editorial content responsive to input into the communication network from the user, wherein the editorial content includes digitally encoded video that the user has linked to the selected portion of the transmitted material; and
storing, in memory connected to the communication network, a form of the editorial content such that the user or other users of the communication network can later access the editorial content responsive to any such user selecting the portion of the material over the communication network.

7. A method as defined in claim 6, wherein storing a form of the editorial content includes identifying from the user's input into the communication network whether that user's editorial content is to be accessible by other users or only said user.

8. A method as defined in claim 6, further comprising transmitting, in association with the material, indicia representing to the user at least relative amounts of editorial content linked with selectable portions of the transmitted material.

9. A method for enabling interactive Biblical commentary and communication via the Internet, wherein Biblical commentary and communication information is stored in computer memory and retrievable therefrom via the Internet and wherein a user has a communication device which includes a display screen and which communicates with the Internet remotely from said computer memory, the method comprising:
in response to a command signal transmitted over the Internet from the user's communication device, transmitting over the Internet to the user's communication device a portion of an electronic version of the Bible included in the Biblical commentary and communication information such that the transmitted portion is at least scrollably visible by the user viewing the display screen;
in response to a selection signal transmitted over the Internet from the user's communication device selecting a verse of the viewed portion, transmitting to the user a list of linked content included in the Biblical commentary and communication information and stored in said computer memory as related to the selected verse, the linked content including at least one digitally encoded video and having been input into said computer memory in response to at least one other user transmitting such linked content for storing in said computer memory; and
in response to an indicator signal from the user indicating a choice from the list of linked content, transmitting to the user the chosen linked content and causing the chosen linked content to be displayed on the display screen with the selected verse.

10. A method as defined in claim 9, further comprising receiving over the Internet user-submitted content transmitted by the present user and related to the selected verse, said user-submitted content including at least one of audio, video, and image media.

11. A method as defined in claim 10, further comprising receiving over the Internet access control data associated with the user-submitted content transmitted by the user.

12. A method as defined in claim 9, further comprising transmitting, in association with the transmitted portion of the Bible, indicia representing to the user at least relative amounts of linked content as related to the transmitted portions of the Bible.

13. A method of interactively delivering editorial content linked with a literary work, comprising:
accessing from a user's computer a website communicating with memory having literary work and editorial content digitally stored therein;
displaying at least a portion of the literary work on a screen of the user's computer;
using a mouse of the user's computer, clicking on a segment of the displayed literary work such that a selection signal is transmitted to the website for identifying the segment selected by the user;
in response to the transmitted selection signal activating transmission from the website memory, displaying, on the user's computer screen in conjunction with at least the displayed segment selected by the user, a list of editorial content linked to the identified segment of the literary work, such displaying of a list of editorial content including showing on the user's computer screen for each entry in the list an icon identifying the media type of the respective entry, said media types including at least one of audio, video, and image;
using the mouse of the user's computer, clicking on an entry in the displayed list of editorial content such that an indicator signal is transmitted to the website indicating the user's choice of editorial content to be received at the user's computer; and
in response to the transmitted indicator signal activating website action, displaying, on the user's computer screen in conjunction with at least the displayed segment selected by the user and within the displayed list of editorial content, the chosen editorial content.

14. A method as defined in claim 13, further comprising adding to the editorial content in the website's memory.

15. A method as defined in claim 14, wherein adding to the editorial content includes transmitting user-defined editorial content from the user's computer to the website, wherein the user-defined editorial content contains any of the media types including audio, video, and image.

16. A method as defined in claim 15, wherein adding to the editorial content further includes defining within the transmitted user-defined editorial content access permission data designating any limit to access of such user-defined editorial content from the website.

17. A method as defined in claim 13, wherein:
displaying the chosen editorial content includes showing on the user's computer screen the icon identifying the media type of the chosen editorial content; and
the method further comprises closing the displayed chosen editorial content, including clicking, using the mouse of the user's computer, on the icon shown for the chosen editorial content.

18. A method as defined in claim 13, further comprising:
using the mouse of the user's computer, clicking on another entry in the displayed list of editorial content such that another indicator signal is transmitted to the website indicating the user's additional choice of editorial content to be received at the user's computer; and
in response to this additional indicator signal being transmitted and activating website action, at least scrollably displaying, on the user's computer screen in conjunction with at least the displayed segment selected by the user and within the displayed list of editorial content, the additional chosen editorial content.

19. A method as defined in claim 13, further comprising displaying, in association with the displayed portion of the literary work, indicia representing to the user at least relative amounts of editorial content linked with selectable portions of the literary work.

20. A method for electronically providing material to a user such that the user can at least receive editorial content linked to a selectable portion of the material, comprising:
transmitting material over a communication network to a user such that the material is displayed on a display screen used by the user, wherein the transmitted material includes selectable portions with which editorial content is linked; and
transmitting, in association with the material for display on the display screen with the material, indicia representing to the user at least relative amounts of editorial content linked with selectable portions of the transmitted material.

21. A method as defined in claim 20, wherein transmitting indicia includes transmitting data signals defining the indicia on the display screen as a graphical interface of different color intensities based on the respective amounts of editorial content linked with the displayed selectable portions of the material.

22. A method as defined in claim 21, wherein the graphical interface is a vertical ribbon having gray-scale bars displayed on the display screen adjacent respective portions of the displayed material.

23. A method of interactively delivering editorial content linked with a literary work, comprising:
accessing from a user's computer a website communicating with memory having literary work and editorial content digitally stored therein;
displaying a portion of the literary work on a screen of the user's computer; and
displaying, on the screen in association with the displayed portion of the literary work, indicia representing at least a relative amount of editorial content linked with the displayed portion of the literary work.

24. A method as defined in claim 23, wherein displaying indicia includes displaying a graphical interface based on the respective amount of editorial content linked with the displayed portion of the material.

25. A method as defined in claim 24, wherein displaying a graphical interface includes displaying a vertical ribbon having a color bar on the screen adjacent the respective portion of the displayed material, including varying the color of the bar as the amount of editorial content linked with the displayed portion of the material changes.
